(19) United States
(12) Patent Application Publication
(10) Pub. No.: US 2025/0260435 A1
(43) Pub. Date: Aug. 14, 2025

(54) INTEGRATED CELLPHONE CASE WITH PERFUME DISPENSER

(71) Applicants: Elvin Hernandez, Miami, FL (US); Ronaldys Gouthman, Miami, FL (US)

(72) Inventors: Elvin Hernandez, Miami, FL (US); Ronaldys Gouthman, Miami, FL (US)

(21) Appl. No.: 18/438,536

(22) Filed: Feb. 12, 2024

(51) Int. Cl. H04B 1/3888; A45D 34/02; H04M 1/04

(52) U.S. Cl. CPC H04B 1/3888; A45D 34/02; H04M 1/04

(57) ABSTRACT

An integrated cell phone case with dispenser is provided. The case includes a cell phone case shell with an integrated dispenser extension region. The case also includes a perfume dispenser assembly. The perfume dispenser assembly includes a perfume bottle. The assembly also includes a refill valve positionable on a bottom side of the perfume bottle. The assembly further includes a spray pump positionable on a top side of the perfume bottle. The assembly additionally includes a push button positionable on a top side of the spray pump. Wherein the perfume dispenser assembly is housed within the integrated dispenser extension region of the cell phone case shell. The case further includes a back plate positionable over the perfume dispenser assembly and a surface of the cell phone case shell. Wherein the integrated cell phone case with a dispenser provides a reusable cell phone case with the ability to dispense perfume.

### FIELD OF THE INVENTION

The present invention relates generally to cell phone cases, and more particularly, to integrated cell phone cases which provide a user the ability to economically and efficiently to stow, carry, and utilize both a cell phone and a perfume dispenser in a unitary device for convenience.

### BACKGROUND OF THE INVENTION

Many methods and systems have been used in unsuccessful attempts to use cell phone cases with various perfume dispensers which typically are standalone items. These devices and methods have not been reliable or effective. Many of the unsuccessful systems are cumbersome, costly and fail to provide a universal common device to utilize a standard cell phone case with a variety of different perfumes with their corresponding dispensers.

As the fashion and digital working industry continues developing, devices which simplify carrying various items, are needed. Additionally, the developing workforce continues to grow in the demographic of younger adults. Quite often, younger adults are in search of universal devices which accomplish various functions within one or fewer devices. Further, the younger generations desire a wider variety of discretionary fashion and beauty brands. Accordingly, the need to provide younger people the ability to use common devices with a growing demand for more and more variety in discretionary fashion and beauty brands continues to increase.

Accordingly, there is an established need for an integrated cell phone case which solves at least one of the aforementioned problems. Further, there is an established need for an integrated cell phone case with a perfume dispenser which can address providing an effective and economical method of providing the use of a cell phone case and providing a variety of different perfumes simultaneously.

### SUMMARY OF THE INVENTION

According to an aspect of the present invention, an integrated cell phone case with a dispenser is provided. The case includes a cell phone case shell with an integrated dispenser extension region. The case also includes a perfume dispenser assembly. The perfume dispenser assembly includes a perfume bottle. The assembly also includes a refill valve positionable on a bottom side of the perfume bottle. The assembly further includes a spray pump positionable on a top side of the perfume bottle. The assembly additionally includes a push button positionable on a top side of the spray pump. Wherein the perfume dispenser assembly is housed within the integrated dispenser extension region of the cell phone case shell. The case further includes a back plate positionable over the perfume dispenser assembly and an inner surface of the cell phone case shell. Wherein the integrated cell phone case with a dispenser provides a reusable cell phone case with the ability to dispense perfume by actuating the push button of the perfume dispenser assembly when the cell phone case shell with the integrated dispenser region houses the perfume dispenser assembly and the back plate is positioned over the perfume dispenser assembly and the inner surface of the cell phone case shell, and forms an integrated cell phone case with a dispenser.

In embodiments, the case can include a soft shell protector positionable on an outer surface of the cell phone case shell.

In embodiments, the case can include an inner case liner positionable over an outer surface of the back plate.

In embodiments, the case can include a perfume bottle which is cylindrical in shape.

In embodiments, the case can include a push button which includes a contoured upper rounded corner configurable to match an outer perimeter of the cell phone case shell.

In embodiments, the case can include a perfume bottle window.

In embodiments, the case can include a curved perfume bottle extension region.

These and other objects, features, and advantages of the present invention will become more readily apparent from the attached drawings and the detailed description of the preferred embodiments, which follow.

### BRIEF DESCRIPTION OF THE DRAWINGS

The features and advantages of the present invention will be better understood when the Detailed Description of the Preferred Embodiments given below is considered in conjunction with the figures provided.

FIGS. 1A and 1B are side perspective views of an assembled integrated cell phone case with dispenser in an embodiment of the present invention;

FIGS. 2A, 2B, and 2C are top, bottom, and side views of an integrated cell phone case with dispenser in an embodiment of the present invention;

FIGS. 3A and 3B are back and front views of an integrated cell phone case with dispenser in an embodiment of the present invention;

FIG. 4 is an exploded view of an integrated cell phone case with dispenser in an embodiment of the present invention;

FIGS. 5A and 5B are exploded and assembled views of an integrated cell phone case with dispenser in an embodiment of the present invention;

FIGS. 6A, 6B, 6C, 6D, and 6E are perspective, top, front, back, and side views of an integrated cell phone case with dispenser in an embodiment of the present invention;

FIGS. 7A, 7B, and 7C are front, back and perspective views of an integrated cell phone case with dispenser in an embodiment of the present invention;

FIGS. 8A, 8B, and 8C are front, back, and perspective views of an integrated cell phone case with dispenser in an embodiment of the present invention; and

FIGS. 9A, 9B, and 9C are front, back, and perspective views of an integrated cell phone case with dispenser in an embodiment of the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

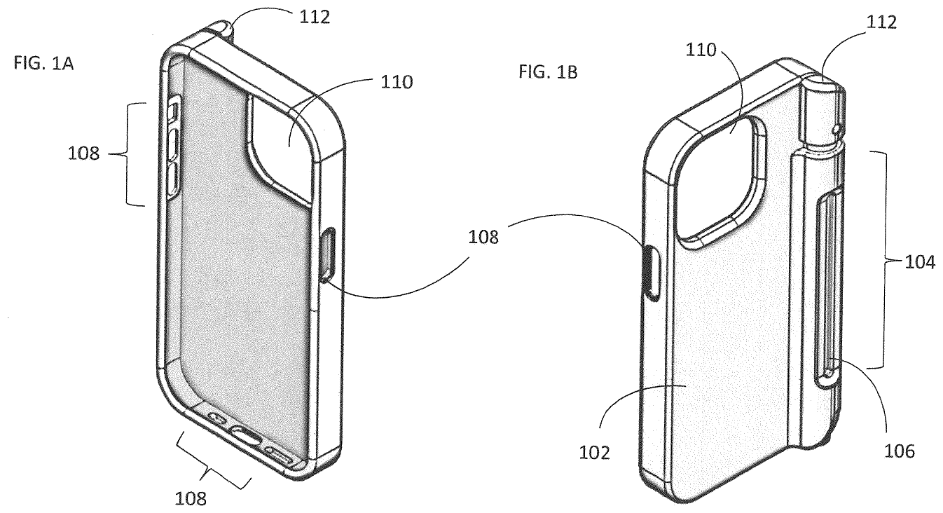

As seen in FIGS. 1A and 1B, perspective views of an integrated cell phone case with dispenser 100 are displayed. The case 100 can include a case shell 102 configured to provide structural protection for a cell phone when the cell phone is stored within the case 100. The case shell 102 can include an integral perfume bottle extension region 104 wherein the perfume bottle extension 104 can include circular and/or cylindrical shapes. The shapes of the perfume bottle extension 104 can be structured to allow a variety of different manufacturers perfume bottles to be utilized with the case 100. The perfume bottle extension 104 can include curved and contoured surfaces integral with the case shell 102 such that holding of the case shell 102 can be ergonomically designed to allow for minimizing hand fatigue. The perfume bottle extension 104 can include a perfume bottle window 106. The window 106 designed to be arranged lengthwise along a longer side of the case to permit a case 100 user to visually observe remaining perfume content of the perfume bottle.

Continuing with FIGS. 1A and 1B, the cell case 100 can include cell phone control accessways 108 configured to allow users of a cell case 100 to operate and control the cell phone while the cell phone is stored within the cell case 100. The accessways 108 can include a variety of shapes and sizes designed to accommodate standard cell phone control interfaces. The case shell 102 can include an optics window 110 wherein the optics window is configured to allow line of sight capabilities with camera, video, and/or other sensor of the cell phone. The cell case 100 can include a push button 112. The push button 112 can allow a user of the cell case 100 to disperse perfume from the cell case 100. The cell case 100 can also include a back plate 114. The back plate 114 designed to allow a back side of the cell phone to abut against a front side of the back plate 114 when the cell phone is stored in the cell case 100 and when the back plate is installed within the cell case 100.

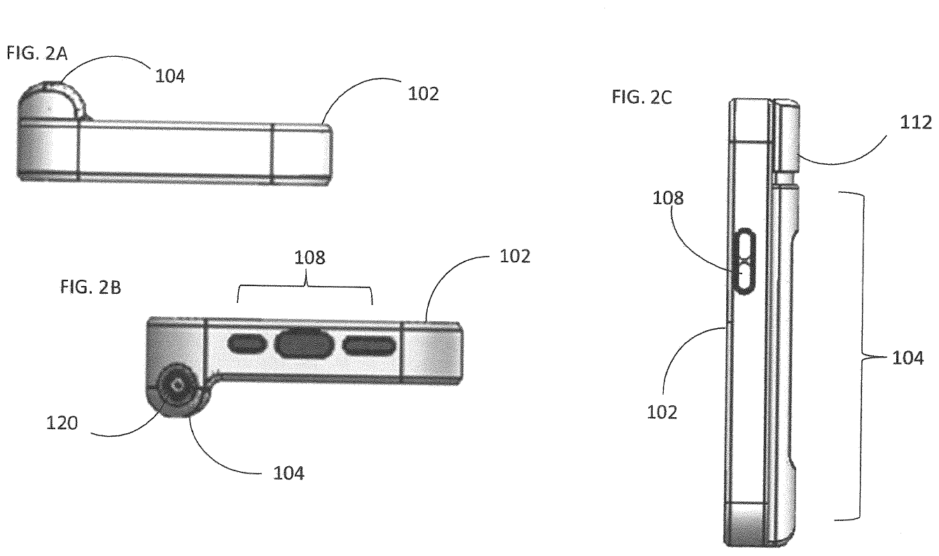

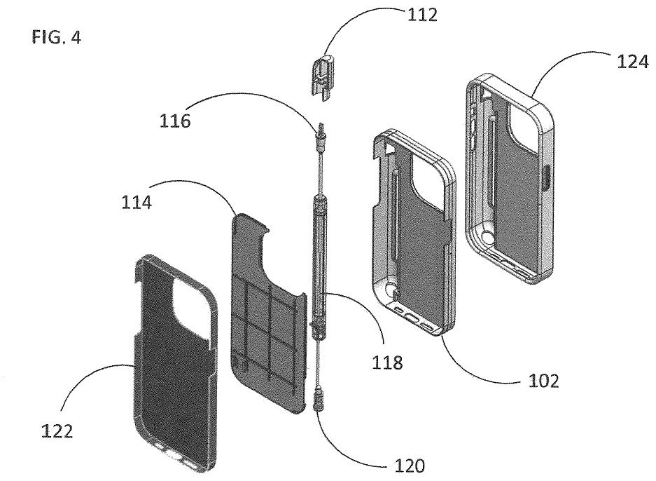

As seen in FIGS. 2A, 2B, and 2C, the cell case 100 can include slim aesthetic profiles with the case shell 102 configured to be portable and to house both the cell phone and a variety of perfumes all in one device. The cell case 100 can include a profile with curved and/or rounded surfaces integral in the case shell 102 and integral with the perfume bottle extension 104. As seen in FIGS. 2B and 2C, the case shell 102 can include cellphone control accessways 108 positionable about surfaces of the cell case 100 and cell shell 102. The push button 112 can be positionable on a top region of the cell case 100 and cell shell 102 and perfume bottle extension region 104 and configured to actuate release of perfume from the cell case 100 when the push button 112 is depressed. As best seen in FIG. 2B, a perfume bottle refill valve 120 can be positionable on a bottom area of the perfume bottle extension 104 and designed to allow perfume to replenish a perfume bottle 118 (as best seen in FIG. 4) as perfume is depleted from use. Additionally, the perfume bottle extension region can be configured with its dimensions so that it serves as a stand of sorts in that as the cell case when positioned on a flat surface, allows a user to view their cell phone at an angle for better viewing of the cell phone screen.

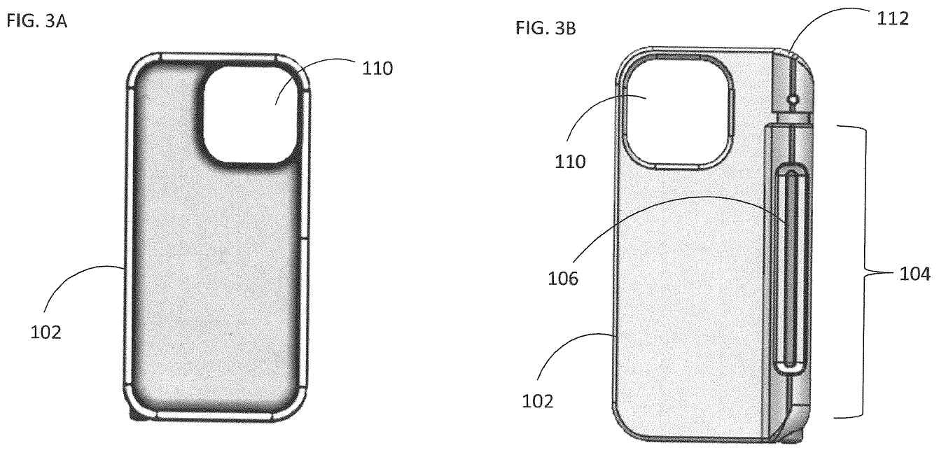

FIGS. 3A and 3B show front and back views of the case shell 102. The case shell 102 can include an optics window 110, a curved push button 112 positionable on top of a perfume bottle extension region 104, a perfume bottle window 106 arranged longitudinally along a length of the perfume extension region 104, and a perfume bottle refill valve 120 positionable on the bottom of the perfume bottle extension region 104.

FIG. 4 displays an exploded view of an integrated cellphone case with a perfume dispenser 100. The integrated case 100 can include a case shell 102, a soft shell protector 124, a perfume bottle 118, a perfume bottle refill valve 120, a spray pump 116, a push button 112, a back plate 114, and an inner case liner 122. The perfume bottle 118, can include a variety of different manufactured perfume bottles provided by a plurality of different brands and providers. The bottle 118 can be configured to be in various shapes including rounded and/or cylindrical. The perfume bottle 118 can be refilled while the integrated case 100 is assembled with the perfume bottle refill valve 120 which is positionable on the bottom of the perfume bottle and accessible external to the integrated case 100. The perfume can be dispensed by pushing down on the push button 112, the button 112 positionable on top of the spray pump and wherein the spray pump is positionable on top of the perfume bottle 118.

The integrated case 100 can also include a soft shell protector 124, the protector 124 designed to provide additional support and protection for the case shell. When assembled, the integrated case 100 can include the perfume bottle 118 positionable within a void of the case shell 102 as defined by the integrated perfume bottle extension region 104 of the case shell 102. Positionable over the spray pump 116, the perfume bottle 118, and the refill valve 120 is the back plate 114, which sandwiches the spray pump 116, the perfume bottle 118, and the refill valve 120 between the back plate 114 and the case shell 102.

In embodiments, the integrated case 100 can include an inner case liner 122, the liner 122 structured to provide an interface between the cell phone and a front side of the back plate 114, when the integrated case 100 is assembled.

The integrated case 100 can be designed to house the cell phone and a perfume dispenser such that when the integrated case 100 is assembled a person can use their cell phone and dispense perfume all in one integrated case 100. Further, the integrated case 100 can be configured to replenish perfume with the refill valve 120, and dispense perfume with the push button 122, at will.

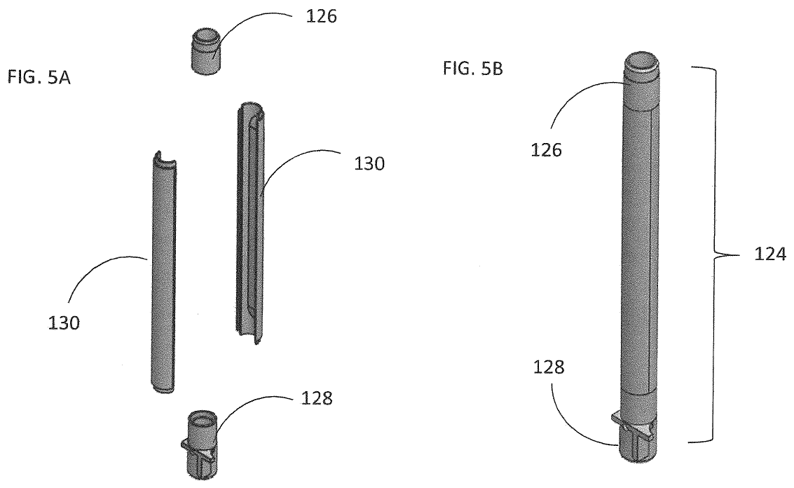

Turning to FIGS. 5A and 5B, in embodiments, the integrated case 100 can include a perfume bottle assembly 124. The assembly 124 can include a spray pump enclosure 126, wherein the spray pump 116 can be housed, a perfume bottle refill valve enclosure 128, wherein the refill valve 120 can be housed, and wherein the perfume bottle assembly can be a separately provided enclosure from a provider and/or it can include a perfume bottle including two perfume bottle halves 130. The perfume bottle assembly may be positionable within the integrated case 100 when assembled and function to contain perfume, dispense perfume when the push button 112 is depressed and/or to replenish perfume with the refill valve 120.

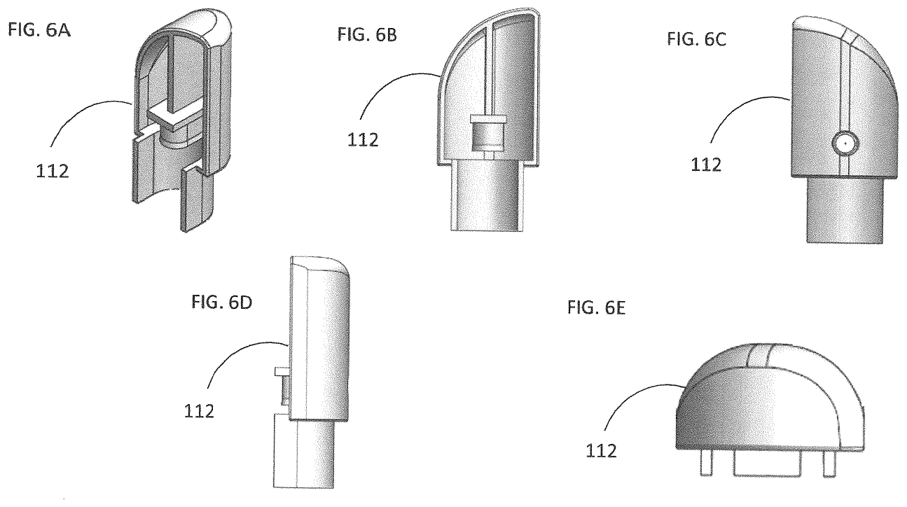

FIGS. 6A, 6B, 6C, 6D, and 6E show various views of the push button 112. As best seen in FIGS. 6A-E, the push button 112 can be contoured to conform with a plurality of cell phones and cellphone cases 100. The push button 112 can be configured to connect directly to the spray pump 116 and arranged such that when the push button 112 is depressed, the spray pump 116 is actuated resulting in perfume being dispensed.

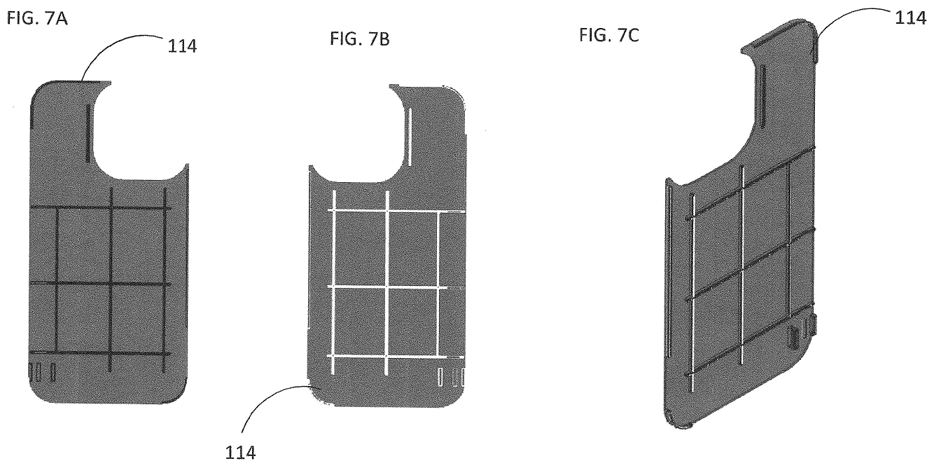

FIGS. 7A, 7B, and 7C display various views of the back plate 114. The back plate 114 can include shapes configured for allowing the optics window 110 of the case to have line of sight capabilities. Additionally, the back plate 114 can include grid type tabs configured to allow spacing between items abutting back and front surfaces of the back plate 114.

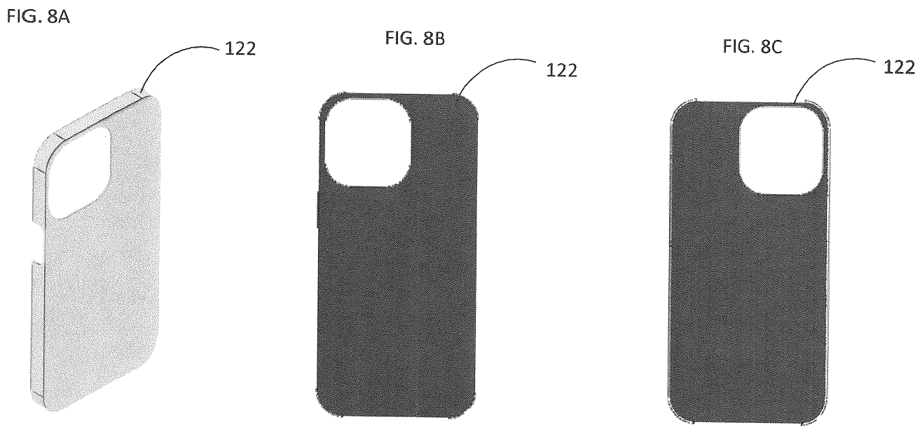

FIGS. 8A, 8B, and 8C display views of the inner case liner 122 in embodiments of the present invention. The liner 122 can be configured to provide a soft surface interface between the cell phone and the back plate 114 of the cell case 100.

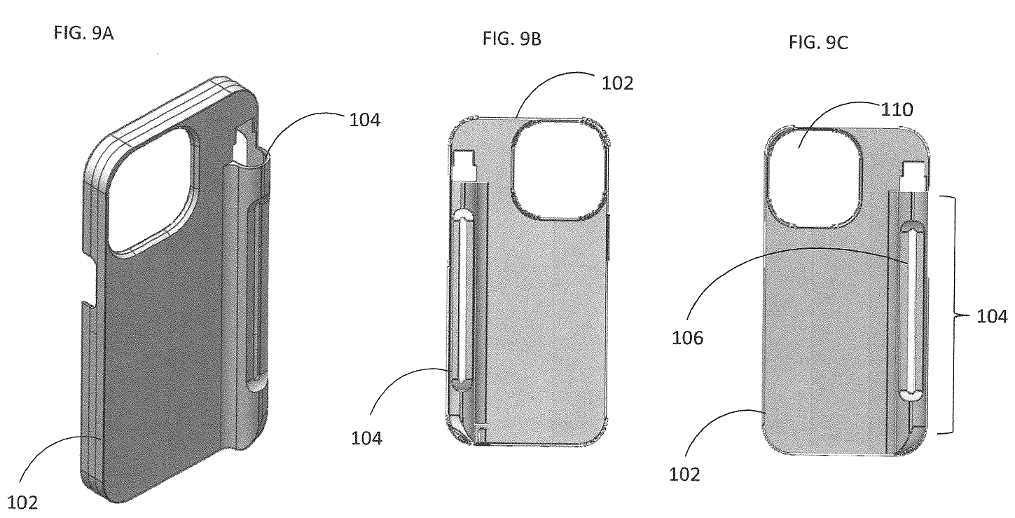

As best seen in FIGS. 9A, 9B, and 9C the cell case 100 can include a case shell 102. The case shell 102 can include integrally a perfume bottle extension region 104, wherein the bottle extension 104 serves to house a perfume bottle 118 and/or to serve as a protrusion above a surface of the case shell 102 wherein the protrusion serves to place the cell phone at an angle when the integrated case 100 is placed on a horizontal surface. The case shell 102 can also include a perfume bottle window positionable on a surface of the perfume bottle extension longitudinally so that as perfume is depleted from the perfume bottle118, a user can replenish the integrated case 100 with perfume by using the refill valve 120.

The integrated case 100 can include a case shell 102 which includes optics window 110 and cellphone control accessways 108 to allow operating the cell phone.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

The present invention has been described with reference to the preferred embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of implementation which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

The present invention has been described with reference to the preferred embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

What it claimed is:

1. An integrated cell phone case with a dispenser comprising:
a cell phone case shell with an integrated dispenser extension region;
a perfume dispenser assembly, the perfume dispenser assembly comprising a perfume bottle;
a refill valve positionable on a bottom side of the perfume bottle;
a spray pump positionable on a top side of the perfume bottle;
a push button positionable on a top side of the spray pump; and
wherein the perfume dispenser assembly is housed within the integrated dispenser extension region of the cell phone case shell;
a back plate positionable over the perfume dispenser assembly and an inner surface of the cell phone case shell; and
wherein the integrated cell phone case with a dispenser provides a reusable cell phone case with the ability to dispense perfume by actuating the push button of the perfume dispenser assembly when the cell phone case shell with the integrated dispenser region houses the perfume dispenser assembly and the back plate is positioned over the perfume dispenser assembly and the inner surface of the cell phone case shell, and forms an integrated cell phone case with a dispenser.

2. The cell phone case with dispenser as recited in claim 1 comprising a soft shell protector positionable on an outer surface of the cell phone case shell.

3. The cell phone case with dispenser as recited in claim 1 comprising an inner case liner positionable over an outer surface of the back plate.

4. The cell phone case with dispenser as recited in claim 1 wherein the perfume bottle is cylindrical in shape.

5. The cell phone case with dispenser as recited in claim 1 wherein the push button includes a contoured upper rounded corner configurable to match an outer perimeter of the cell phone case shell.

6. The cell phone case with dispenser as recited in claim 1 wherein an outer surface of the integrated dispenser extension region includes a perfume bottle window.

7. The cell phone case with dispenser as recited in claim 1 the integrated dispenser region includes a curved perfume bottle extension region.
